(19) United States
(12) Patent Application Publication
(10) Pub. No.: US 2022/0380562 A1
(43) Pub. Date: Dec. 1, 2022

(54) COMPOSITION FOR FORMING HARD COAT OF RESIN SUBSTRATE AND LAMINATE USING THE SAME

(71) Applicant: NIPPON FINE CHEMICAL CO., LTD., Osaka-shi, Osaka (JP)

(72) Inventors: Hiroyoshi Warabino, Kakogawa-shi, Hyogo (JP); Yoshiaki Miyamoto, Kakogawa-shi, Hyogo (JP); Toshiya Ueno, Kakogawa-shi, Hyogo (JP)

(73) Assignee: NIPPON FINE CHEMICAL CO., LTD., Osaka-shi, Osaka (JP)

(21) Appl. No.: 17/619,687

(22) PCT Filed: Jun. 16, 2020
(86) PCT No.: PCT/JP2020/023588

§ 371 Date: Dec. 16, 2021

(30) Foreign Application Priority Data
Jun. 18, 2019 (JP) 2019-112942

(51) Int. Cl. C08J 7/046; C08K 3/36; C08K 5/5419; C08K 5/5435; B32B 33/00; G02B 1/14; B32B 27/08; B32B 27/28

(52) U.S. Cl. CPC C08J 7/046; C08K 3/36; C08K 5/5419; C08K 5/5435; B32B 33/00; G02B 1/14; B32B 27/08; B32B 27/281; C08J 2479/08; C08J 2379/08; B32B 2307/536

(57) ABSTRACT

The present invention provides a composition for forming a hard coat and a laminate using the same. The composition for forming a hard coat includes at least metal oxide fine particles; a hydrolysate of an organosilicon compound; an adhesion promoting component having an alkoxysilyl group; a curing catalyst; and a solvent, wherein by introducing, as the organosilicon compound, an organosilicon compound having a hydrocarbon group having (6 to 18) carbon atoms substituted with a glycidoxy group, and an organosilicon compound having a hydrocarbon group having (1 to 5) carbon atoms substituted with a glycidoxy group, even when applied to a flexible resin substrate, the composition for forming a hard coat has excellent adhesion and scratch resistance, and bending resistance (crack resistance) and surface hardness as well.

### TECHNICAL FIELD

The present invention relates to a composition for forming a hard coat for surface protection of a resin substrate. More specifically, the present invention relates to a composition for forming a hard coat for protecting a surface of a hard plastic substrate such as a plastic lens or film made of polycarbonate, a flexible resin film made of polyimide used for an electronic material, or the like, and a laminate using the same.

### BACKGROUND ART

In the related art, in order to protect the surface of plastic chemical products such as polycarbonate from scratches, stains, and the like, a treatment with a hard coat agent has been widely performed. However, even when an attempt is made to form a hard coat layer by applying a coating composition to a plastic substrate, the adhesion is insufficient and the plastic substrate cannot withstand practical use. Therefore, in order to impart adhesion, a two-step process of applying a primer liquid to a plastic substrate and then applying a hard coat agent has been required. Particularly, in a plastic substrate made of polycarbonate, adhesion to a hard coat layer was poor, and thus a primer treatment was indispensable.

There has been disclosed a coating composition that adheres to a thermoplastic sheet by containing an adhesion promoting component in a polycarbonate substrate so as to obtain a hard coat layer that adheres even without a primer treatment (Patent Documents 1 to 3); however, sufficient adhesion has not been obtained while maintaining performance such as hardness and appearance.

In addition, with the rapid progress of displays such as liquid crystal, organic EL, and electronic paper, and electronics such as a solar cell and a touch panel, it has been required to reduce the thickness and weight of a device, and further to make the device flexible. Therefore, instead of glass substrates used in these devices, a resin film substrate capable of reducing the thickness, weight, and flexibility has been studied.

Polyimides and wholly aromatic polyamides (aramids) have been widely studied as glass substitute substrates in terms of excellent heat resistance and mechanical properties thereof.

The inventors of the present invention have already developed a composition for forming a hard coat which has excellent adhesion and scratch resistance even without a primer treatment to various thermoplastic or thermosetting resin substrates such as a polycarbonate resin substrate and a polyimide resin substrate, and further has bending resistance (crack resistance) and surface hardness even when the composition is applied to a flexible resin substrate (Patent Literature 4).

### CITATION LIST

### Patent Literature

Patent Literature 1: JP 2006-251413 A
Patent Literature 2: JP H 06-256718 A
Patent Literature 3: JP 2001-247769 A
Patent Literature 4: JP 2017-104947 A

### SUMMARY OF INVENTION

### Technical Problem

Currently, mobile devices such as smartphones and tablets are mainly one-screen devices. The smartphones are small, which makes it difficult to work on screens, and tablets are large, which makes it inconvenient to carry. Therefore, a foldable smartphone having two to three screens has been developed. Such a foldable smartphone is convenient to carry and can be used as a tablet when expanded. However, since the screen is divided, the work is limited.

Most recently, a one-screen foldable smartphone has been developed and can be used as a one-screen tablet when expanded.

Thus, it is necessary to develop a composition for forming a hard coat having both high bending resistance and high surface hardness for a flexible material used for a screen of a mobile device.

Therefore, an object of the present invention is to provide a composition for forming a hard coat, which has excellent adhesion and scratch resistance on a substrate of a thermoplastic resin and a thermosetting resin, and further has improved bending resistance (crack resistance) and surface hardness even when the composition is applied to a resin substrate that can be made flexible. Furthermore, a laminate using such a composition for forming a hard coat is also provided.

### Solution to Problem

The inventors of the present invention have found that in a composition containing at least metal oxide fine particles, an organosilicon compound or a hydrolysate thereof, an adhesion promoting component having an alkoxysilyl group, a curing catalyst, and a solvent, a composition for forming a hard coat having excellent adhesion and scratch resistance with respect to various thermoplastic or thermosetting resin substrates such as a polycarbonate resin substrate and a polyimide resin substrate can be provided by using organosilicon having a hydrocarbon group having 6 or more carbon atoms substituted with an epoxy group and organosilicon having a hydrocarbon group having 5 or less carbon atoms substituted with an epoxy group, as organosilicon, and a silane compound having no epoxy group.

Since the composition for forming a hard coat of the present invention contains an adhesion promoting component having an alkoxysilyl group as a reactive functional group, it is possible to form a hard coat that adheres to a polycarbonate substrate or a polyimide substrate without a primer treatment which has been indispensable heretofore.

### Advantageous Effects of Invention

When the composition for forming a hard coat of the present invention is used, it is not necessary to apply a primer liquid to a resin substrate in order to impart adhesion, and a hard coat layer having excellent adhesion and also having high scratch resistance, bending resistance, and surface hardness can be formed.

### BRIEF DESCRIPTION OF DRAWINGS

FIG. 1 is a schematic view for explaining a procedure for forming a hard coat on a resin substrate using the composition for forming a hard coat of the present invention.

FIG. 2 is a schematic view for explaining a procedure for forming a hard coat on a resin substrate using the composition for forming a hard coat in the related art.

### MODE FOR CARRYING OUT THE INVENTION

A composition for forming a hard coat of the present invention includes at least:

a component A: metal oxide fine particles;

a component B: an organosilicon compound or a hydrolysate thereof;

a component C: an adhesion promoting component having an alkoxysilyl group;

a component D: a curing catalyst; and

a component E: a solvent.

### <Metal Oxide Fine Particles>

The metal oxide fine particles are used for improving the scratch resistance of the hard coat to be formed and adjusting the refractive index. Examples of the metal oxide fine particles forming a hard coat layer include titanium oxide, silicon oxide, zirconium oxide, aluminum oxide, iron oxide, antimony oxide, tin oxide, tungsten oxide, composites thereof, and the like, and titanium oxide, silicon oxide, zirconium oxide, and tin oxide are preferable. The metal oxide fine particles can be used as, for example, a colloidal sol dispersed in water, an organic solvent, or a mixture thereof.

### <Organosilicon Compound and Hydrolysate Thereof>

The organosilicon compound having a hydrolyzable functional group is used to increase a crosslinking density of a hard coat by formation of a siloxane bond by dehydration condensation between silanol groups generated by hydrolysis or formation of a chemical bond by reaction between organic functional groups. Specific examples of the hydrolyzable functional group include alkoxy groups such as a methoxy group and an ethoxy group, halogen groups such as a chloro group and a bromo group, and acyloxy groups. These hydrolyzable functional groups are easily hydrolyzed in an aqueous solution to generate a silanol group.

As the organosilicon compound, a silane coupling agent having a hydrocarbon group substituted with an epoxy group is used. More specifically, an organosilicon compound represented by a general formula (1), a hydrolysate thereof, and a partially hydrolyzed oligomer thereof can be used.

[Chem. 1]

(R¹O)ₐSi(R²)₄₋ₐ (1)

(In the formula, a represents an integer of 1 to 3, one or more R¹s represent the same or different hydrocarbon groups having 1 to 3 carbon atoms, respectively, and one or more R²s represent the same or different hydrocarbon groups having 1 to 18 carbon atoms substituted with a glycidoxy group, respectively).

In the present invention, although an organosilicon compound having a hydrocarbon group having 6 to 18 carbon atoms in which R² is substituted with a glycidoxy group in the general formula (1) is used, an organosilicon compound having a hydrocarbon group having 6 to 12 carbon atoms is preferably used, and an organosilicon compound having a hydrocarbon group having 6 to 10 carbon atoms is more preferably used.

In the present invention, in order to realize high hardness, an organosilicon compound having a hydrocarbon group having 1 to 5 carbon atoms in which R² is substituted with a glycidoxy group is also used; however, an organosilicon compound having a hydrocarbon group having 1 to 3 carbon atoms is preferably used, and an organosilicon compound having a hydrocarbon group having 2 or 3 carbon atoms is more preferably used.

As described above, a mixture of an organosilicon compound having a carbon hydrogen group having 6 or more carbon atoms (6 to 18), which is a relatively long chain (here, referred to as “long-chain organosilicon compound”), in order to improve bending resistance, and an organosilicon compound having a carbon hydrogen group having 5 or less carbon atoms (1 to 5), which is a relatively short chain (here, referred to as “short-chain organosilicon compound”), in order to maintain the hardness, is used.

In the present invention, in order to obtain a composition for forming a hard coat having both high bending resistance and high surface hardness, the appropriate mass ratio of the long-chain organosilicon compound: the short-chain organosilicon compound is 50:50 to 0:100 as a solid content composition, and more specifically, 33:67 to 50:50.

Furthermore, as the organosilicon compound, a silane compound having no epoxy group is used. More specifically, a bistrialkoxysilyl compound represented by a general formula (2) can also be used.

[Chem. 2]

(R³O)₃Si—(CH₂)_{b}—Si(OR)₃ (2)

(In the formula, b represents an integer of 1 to 3, three R³s represent the same or different hydrocarbon groups having 1 to 3 carbon atoms, respectively, and three R⁴s represent the same or different hydrocarbon groups having 1 to 3 carbon atoms, respectively).

In the present invention, as the organosilicon compound, it is desirable to use a silane compound having no epoxy group in combination with the above-described mixture of the long-chain organosilicon compound and the short-chain organosilicon compound.

Examples of the silane compound having no epoxy group include a silyl compound in which two trialkoxysilyl groups are bonded to alkane, such as bis(triethoxysilyl) ethane (BTEE). These can be used alone or in combination of two or more.

### <Adhesion Promoting Component Having Alkoxysilyl Group>

As the adhesion promoting component, various compounds such as polyurethane, polyester, polycarbonate, and polyester carbonate can be applied.

For the introduction of the alkoxysilyl group into these adhesion promoting components, for example, an alkoxysilane compound having an isocyanate group can be chemically introduced into the polymer having a hydroxy group as a functional group by a urethanization reaction, but the invention is not limited thereto.

By introducing an alkoxysilyl group as a reactive functional group, a silanol group generated by the hydrolysis can form a covalent bond by a dehydration condensation reaction with a hydroxyl group on the surface of the metal oxide fine particles or a silanol group generated by the hydrolysis of the organosilicon compound. As a result, the adhesion promoting component can be incorporated and fixed in the coating film via a covalent bond, and thereby a decrease in adhesion due to a heat resistance test or a change with time of the hard coat film is suppressed, and stable adhesion can be obtained. In addition, by introducing an alkoxysilyl group into the adhesion promoting component, the compatibility of the adhesion promoting component in the hard coat resin is improved, and thereby whitening of the hard coat film after curing can be suppressed.

As the adhesion promoting component, for example, a compound, which has an alkoxysilyl group at both ends, represented by the following general formula (3) can be used.

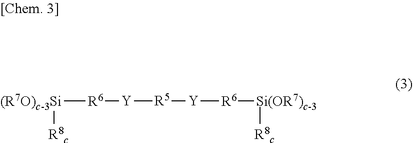

(In the formula, c represents an integer from 0 to 2, R⁵ represents an adhesion promoting polymer main chain selected from the group consisting of polyurethane, polyester, polycarbonate, and polyester carbonate, two R⁶s represent the same or different alkylene groups having 1 to 20 carbon atoms, respectively, the alkylene group may have an unsaturated hydrocarbon group, an aromatic hydrocarbon group, an alicyclic hydrocarbon group or a heteroatom, one or more R⁷s and R⁸s represent the same or different alkyl groups having 1 to 4 carbon atoms, respectively, and two Ys are the same or different chemical bonds selected from the group consisting of an amide bond, an imide bond, an urethane bond, a urea bond, an ether bond, an ester bond, a carbonate bond, a sulfide bond, a thiourethane bond, a thiourea bond, a thioester bond, respectively).

In a case of a polyurethane-based polymer main chain, R⁵ is represented by the following general formula (4).

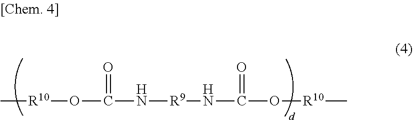

(In the formula, d represents an integer corresponding to the molecular weight of the polymer main chain of 500 to 50,000, a plurality of R⁹s and R¹⁰s represent the same or different alkylene groups having 1 to 20 carbon atoms, respectively, the alkylene group may have an unsaturated hydrocarbon group, an aromatic hydrocarbon group, an alicyclic hydrocarbon group or a heteroatom).

Alternatively, examples thereof include polyurethane obtained by reacting polyol such as polyether polyol, polyester polyol, or polyether ester polyol with an isocyanate group-containing compound having at least two isocyanate groups per molecule described later. Examples of the isocyanate group-containing compound having at least two isocyanate groups per molecule include the following aliphatic polyisocyanate, aromatic polyisocyanate, and araliphatic polyisocyanate. Alternatively, a mixture thereof may be used.

Examples of the aliphatic polyisocyanate include trimethylene diisocyanate, tetramethylene diisocyanate, hexamethylene diisocyanate (HDI), pentamethylene diisocyanate, 1,2-propylene diisocyanate, 2,3-butylene diisocyanate, 1,3-butylene diisocyanate, dodecamethylene diisocyanate, 2,4,4-trimethylhexamethylene diisocyanate, lysine isocyanate, hydrogenated xylene diisocyanate, hydrogenated diphenylmethane diisocyanate, 1,3-bis(diisocyanate methyl) cyclohexane, and 4,4′-dicyclohexylmethane diisocyanate.

Examples of the aromatic polyisocyanate include 1,3-phenylene diisocyanate, 4,4′-diphenyl diisocyanate, 1,4-phenylene diisocyanate, 4,4′-toluidine diisocyanate, 2,4,6-triisocyanate toluene, 1,3,5-triisocyanate benzene, dianisidine diisocyanate, 4,4′-diphenyl ether diisocyanate, 4,4′,4″-triphenylmethane triisocyanate, xylene-1,4-diisocyanate, xylene-1,3-diisocyanate, 2,4′-diphenylmethane diisocyanate, 2,2′-diphenylmethane diisocyanate, and polymethylene polyphenylene polyisocyanate (MDI).

Examples of the araliphatic polyisocyanate include ω,ω′-diisocyanate-1,3-dimethylbenzene, 0,0′-diisocyanate-1,4-dimethylbenzene, ω,ω′-diisocyanate-1,4-diethylbenzene, 1,4-tetramethylxylylene diisocyanate, and 1,3-tetramethylxylylene diisocyanate.

In a case of a polyester-based polymer main chain, R⁵ is represented by a general formula (5):

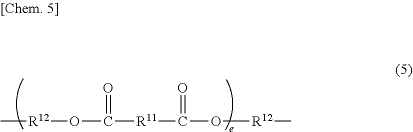

(in the formula, e represents an integer corresponding to the molecular weight of the polymer main chain of 500 to 50,000, a plurality of R¹¹s and R¹²s represent the same or different alkylene groups having 1 to 20 carbon atoms, respectively, the alkylene group may have an unsaturated hydrocarbon group, an aromatic hydrocarbon group, an alicyclic hydrocarbon group or a heteroatom).

In a case of a polycarbonate-based polymer main chain, R⁵ is represented by a general formula (6):

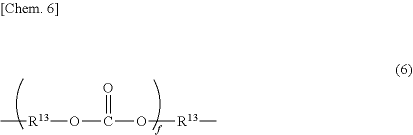

(in the formula, f represents an integer corresponding to the molecular weight of the polymer main chain of 500 to 50,000, a plurality of R¹³s represent the same or different alkylene groups having 1 to 20 carbon atoms, respectively, the alkylene group may have an unsaturated hydrocarbon group, an aromatic hydrocarbon group, an alicyclic hydrocarbon group or a heteroatom).

In a case of a polyester carbonate-based polymer main chain, R⁵ is represented by a general formula (7):

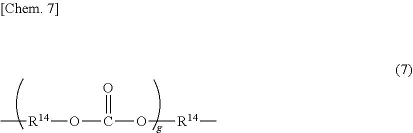

[in the formula, g represents an integer corresponding to 500 to 50000 in molecular weight of the polymer main chain, and a plurality of R¹⁴s are the same as or different from each other, and are each represented by a general formula (8):

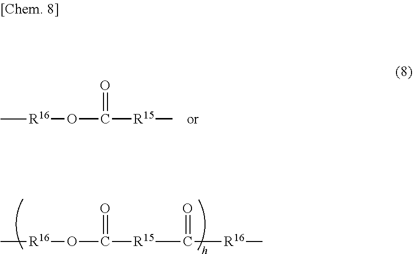

(in the formula, h represents an integer corresponding to the molecular weight of R¹⁴ of 150 to 25000, a plurality of R¹⁵s and R¹⁶s represent the same or different alkylene groups having 1 to 20 carbon atoms, respectively, the alkylene group may have an unsaturated hydrocarbon group, an aromatic hydrocarbon group, an alicyclic hydrocarbon group or a heteroatom)].

In the present specification, for example, the notation “one or more R⁷s and R⁸s represent the same or different alkyl groups having 1 to 4 carbon atoms, respectively”, means that each group of one or more R⁷ and one or more R⁸ is independently an alkyl group having 1 to 4 carbon atoms, and the groups may be the same alkyl group or different alkyl groups. The same applies to other similar notations.

### <Curing Catalyst>

Examples of a curing catalyst that can be miscible in the coating composition of the present invention include (i) metallic acetylacetonate; (ii) diamide; (iii) imidazole; (iv) amine and ammonium salt; (v) organic sulfonic acid and amine salt thereof; (vi) carboxylic acids and alkali metal salt thereof; (vii) alkali metal hydroxide; (viii) fluoride salt; (ix) organic tin compound; and (x) perchlorate.

Examples of such a catalyst include as group (i), acetylacetonates of aluminum, zinc, iron and cobalt; as a group (ii), dicyandiamide; as a group (iii), 2-methylimidazole, 2-ethyl-4-methylimidazole and 1-cyanoethyl-2-propylimidazole; as a group (iv), benzyldimethylamine and 1,2-diaminocyclohexane; as a group (v), trifluoromethanesulfonic acid; as a group (vi), sodium acetate; as a group (vii), sodium hydroxide and potassium hydroxide; as a group (viii), tetra n-butylammonium fluoride; as a group (ix), dibutyl tin dilaurate; and as a group (x), magnesium perchlorate and aluminum perchlorate.

### <Solvent>

Examples of volatile solvents include water, alcohols such as methanol, ethanol, and isopropanol, glycol ethers such as propylene glycol monomethyl ether, glycol esters such as ethylene glycol monoethyl ether acetate, ketones such as methyl ethyl ketone and acetylacetone, and esters such as ethyl acetate and butyl acetate. These volatile solvents may be used alone or in combination of two or more kinds thereof.

These volatile solvents can also be added separately to the composition, but also include other components such as solvents derived from colloidal sols dispersed in water, organic solvents or mixtures thereof.

### <Others>

In the composition for forming a hard coat of the present invention, an anti-blocking agent, a colorant, an ultraviolet absorber, a light stabilizer, an antioxidant, and the like may be added to the hard coat agent as desired to the extent that it does not adversely affect the effects of the present invention.

<Substrate to which Composition for Forming Hard Coat of the Present Invention is Applied>

The composition for forming a hard coat of the present invention can be applied to a film including a resin selected from the group consisting of polycarbonate, polyimide, polyamide, polyaramid, polyester, a cycloolefin polymer, cellulose triacetate, polyacrylate, polymethylpentene, polyamide, polyetherimide, a sulfone-based resin, polyphenylene sulfide, polyetheretherketone, a fluorine-based resin, an epoxy resin, an acrylonitrile-butadiene-styrene copolymer (ABS), an acrylonitrile-styrene copolymer (AS), a methylmethacrylate-styrene copolymer pair (MS), and the like, and a film including a composite material thereof.

For optical use, a film of an optical resin selected from the group consisting of polycarbonate, polyimide, polyamide, polyaramid, polyester, a cycloolefin polymer, cellulose triacetate, and the like, or a blend resin of two or more thereof is suitable.

### <Method for Forming Hard Coat on Resin Substrate>

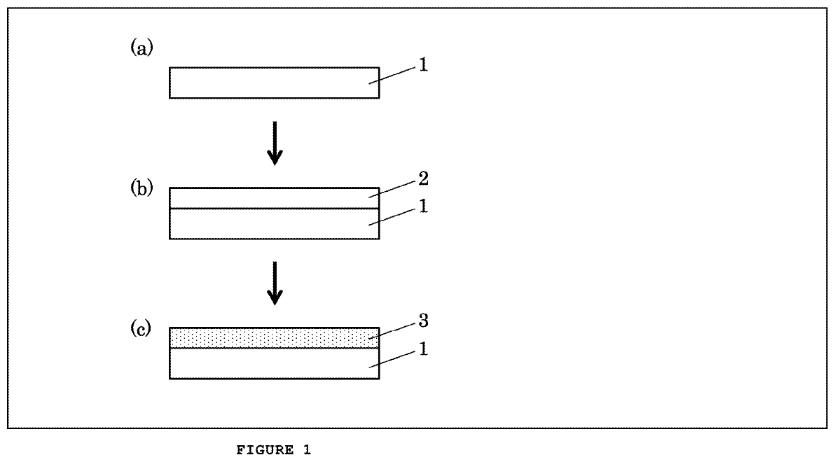

A method for forming a hard coat on a resin substrate using the composition for forming a hard coat of the present invention is described (FIG. 1).

A composition for forming a hard coat is applied onto a resin substrate 1 such as a thermoplastic resin or a thermosetting resin (FIG. 1a) by a general method such as dip coating, roll coating, spin coating, flow coating, spray coating, or gravure coating to form a resin layer 2 (FIG. 1b). The obtained resin layer 2 is heated and cured to form a hard coat 3 as a cured product, thereby preparing a laminate of a resin substrate and a hard coat layer directly formed on the resin substrate (FIG. 1c).

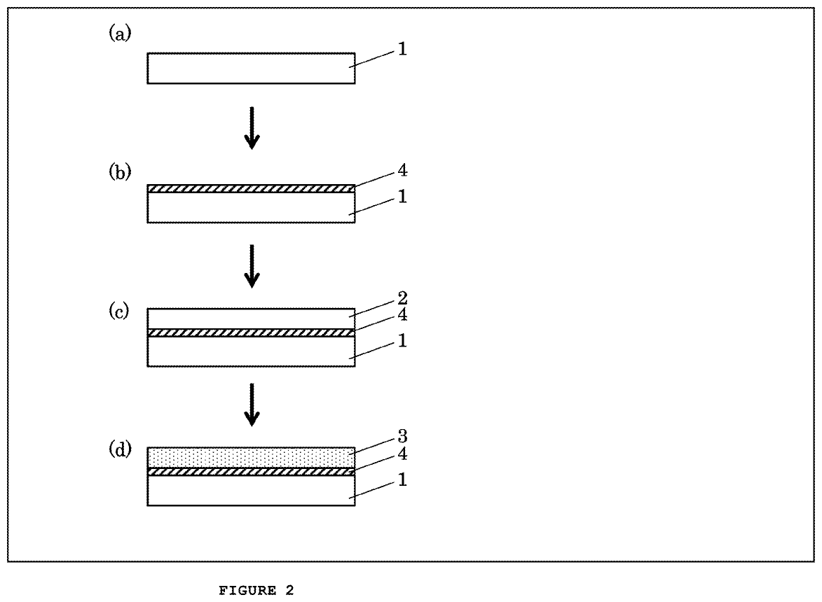

On the other hand, when a composition for forming a hard coat in the related art is used, a primer 4 is first applied to the surface of the resin substrate 1 to perform a surface treatment (FIG. 2b). A composition for forming a hard coat is applied onto the primer-treated surface to form a resin layer 2 (FIG. 2c). The obtained resin layer 2 is heated and cured to form a hard coat 3, thereby obtaining a laminate of a resin substrate and a hard coat layer surface-treated with a primer (FIG. 2d).

That is, since the composition for forming a hard coat of the present invention has high adhesion to a resin substrate, when the composition of the present invention is used, there is no need to perform a primer treatment, and a laminate including two layers of a resin substrate and a hard coat layer can be obtained by directly applying the composition onto a resin substrate and curing the composition.

For example, when the present invention is applied to a polycarbonate film, a primer treatment is not required, so that improvement in productivity and improvement in product yield by omitting the primer treatment step can be expected. In addition, even when used as a composition for a hard coat for a flexible substrate for electronics, which has not been developed so far, the composition exhibits sufficient adhesion, bending resistance, and surface hardness.

### <Formation of Antireflection Layer and Antifouling Layer on Hard Coat>

In the present invention, an antireflection layer 5 can be formed on the hard coat layer 3, and an antifouling layer 6 can be further formed thereon (not shown).

### EXAMPLES

Hereinafter, the present invention will be specifically described with reference to examples, but the present invention is not limited only to the aspects described in these examples.

### Production Example 1

### [Composition for Forming Hard Coat and Hard Coat Film]

### <Synthesis of Adhesion Promoting Component>

9.92 parts by mass of 3-isocyanatopropyltriethoxysilane was added dropwise to a mixed solution of 40.0 parts by mass of polyester polyol (hydroxyl value: 56.2 mg KOH/g), 40.0 parts by mass of dry acetonitrile, and 0.03 parts by mass of dibutyltin dilaurate. The mixture was reacted overnight at 70° C. under a nitrogen stream to introduce an alkoxysilyl group to the end of the polyester polyol, thereby obtaining a product having a nonvolatile solid content of 50.5%.

Since disappearance of absorption of an isocyanate group was checked by measurement of an infrared absorption spectrum of the obtained product, this product was used as an adhesion promoting component (adhesive polymer).

### <Preparation of Composition for Forming Hard Coat>

A mixture of 20.5 parts by mass of 3-glycidoxypropyltrimethoxysilane (GPTMS) as a short-chain organosilicon compound, 11.8 parts by mass of bis (triethoxysilyl) ethane (BTEE) as a silane compound having no epoxy group, and 4.0 parts by mass of the adhesive polymer synthesized above was added dropwise to a stirred mixture of 25.0 parts by mass of water-dispersed colloidal silica sol (solid content concentration 20%) and 40.8 parts by mass of silica sol dispersed in isopropanol (IPA) (Solid content concentration 30%; IPA-ST available from Nissan Chemical Industries, Ltd.), and the mixed solution was stirred at 30° C. for 2 hours. After cooling, 2.23 parts by mass of an aluminum-based curing catalyst and 0.5 parts by mass of a silicone-based surfactant were added and stirred at room temperature for 2 hours to prepare a composition for forming a hard coat 1. The solid content composition of the composition for forming a hard coat is shown in Table 1.

### <Preparation of Hard Coat Film>

The composition for forming a hard coat was applied onto a plastic film substrate made of a polyethylene terephthalate resin or a plastic film substrate made of a polyimide resin with a Meyer bar, preliminarily dried at 80° C. for 1 minute, and then thermally cured at 130° C. for 2 minutes to obtain a hard coat film 1 having a hard coat layer on the surface.

### [Evaluation of Characteristics of Hard Coat Layer]

Each characteristic of the hard coat film 1 obtained in the above production example was measured, and the results are shown in Table 1. Measurement conditions of the characteristics will be described later.

### Production Examples 2 to 9

### [Composition for Forming Hard Coat and Hard Coat Film]

### <Preparation of Composition for Forming Hard Coat>

In the same manner as in Production Example 1, by using 8-glycidoxyoctyltrimethoxysilane (GOTMS) as the long-chain organosilicon compound and 3-glycidoxypropyltrimethoxysilane (GPTMS) as the short-chain organosilicon compound, compositions for forming a hard coat 2 to 9 having different mass ratios of the long-chain organosilicon compound to the short-chain organosilicon compound were prepared. The solid content composition of the composition for forming a hard coat is shown in Table 1.

### <Preparation of Hard Coat Film>

Hard coat films 2 to 9 having a hard coat layer on a surface thereof were obtained in the same manner as in Production Example 1.

### [Evaluation of Characteristics of Hard Coat Layer]

The characteristics of the hard coat films 2 to 9 obtained in the above Production Examples 2 to 9 were measured, and the results are shown in Table 1. Measurement conditions of the characteristics will be described later.

### Production Example 10

### [Composition for Forming Hard Coat and Hard Coat Film]

### <Preparation of Composition for Forming Hard Coat>

A composition for forming a hard coat 10 was prepared in the same manner as in Production Example 4 except that bis(triethoxysilyl) ethane (BTEE), which was a silane compound having no epoxy group, was not used in Production Example 4. The solid content composition of the composition for forming a hard coat is shown in Table 1.

### <Preparation of Hard Coat Film>

A hard coat films 10 having a hard coat layer on a surface thereof was obtained in the same manner as in Production Example 4.

### [Evaluation of Characteristics of Hard Coat Layer]

Each characteristic of the hard coat film 10 obtained in the above Production Example 10 was measured, and the results are shown in Table 1. Measurement conditions of the characteristics will be described later.

TABLE 1

| Hard coat film | | 1 | 2 | 3 | 4 | 5 | 6 | 7 | 8 | 9 | 10 |
|---|---|---|---|---|---|---|---|---|---|---|---|
| Compound | GOTMS | 0 | 20 | 33 | 35 | 40 | 42 | 50 | 75 | 100 | 35 |
| containing | GPTMS | 100 | 80 | 67 | 65 | 60 | 58 | 50 | 25 | 0 | 65 |
| epoxy group | | | | | | | | | | | |
| Mass ratio*¹ | | | | | | | | | | | |
| Compound | BTEE | 30 | 30 | 31 | 32 | 33 | 30 | 31 | 31 | 31 | 0 |
| containing no | | | | | | | | | | | |
| epoxy group | | | | | | | | | | | |
| Mass ratio*² | | | | | | | | | | | |
| Mandrel test | Number of passes | 10 | 5 | 15 | 40 | 40 | 40 | 30 | 40 | 20 | 4 |
| R = 1 mm | (10,000 times) | | | | | | | | | | |
| (outward | Number of fails | 15 | 10 | 20 | 45 | 45 | 45 | 35 | 45 | 25 | 5 |
| bending) | (10,000 times) | | | | | | | | | | |

| | | | | | | | | | | |
|---|---|---|---|---|---|---|---|---|---|---|
| Pencil hardness | 4H | 4H | 4H | 4H | 4H | 4H | 4H | 4H | 4H | 3H |
| Scratch resistance | A | A | A | A | A | A | A | A | B | A |

^{*1}Mass ratio of solid content of GOTMS:GPTMS
^{*2}Mass ratio of solid content of BTEE when (GOTMS + GPTMS) is set as 100

### <Evaluation Results>

In the hard coat film 1 prepared using a composition for forming a hard coat containing 100 mass % of a short-chain organosilicon compound (GPTMS), the scratch resistance was good, but in the mandrel test (bending resistance test), the hard coat film did not pass 150,000 times of bending at a radius of 1 mm (outward bending test).

In a case of the hard coat film 3 prepared using a composition for forming a hard coat in which a long-chain organosilicon compound (GOTMS) was blended and 33 mass % of the long-chain organosilicon compound (GOTMS) was used, the film passed 150,000 times of bending with a radius of 1 mm (outward bending test), which exceeded the result of the hard coat film 4. Further, when the blending amount of the long-chain organosilicon compound (GOTMS) increased to 35 mass %, the resin composition passed 400,000 or more times of bending with a radius of 1 mm (outward bending test), and passed 300,000 to 400,000 times of bending with a radius of 1 mm (outward bending test) up to 75 mass %. In this blending region, the scratch resistance was also good.

Furthermore, when the blending amount of the long-chain organosilicon compound (GOTMS) was 100 mass %, the sample failed to be bent 250,000 times at a radius of 1 mm (outward bending test), and the scratch resistance was also deteriorated.

From the above, it was found that in order to obtain a composition for forming a hard coat having both high bending resistance and high surface hardness, the appropriate mass ratio of the long-chain organosilicon compound: the short-chain organosilicon compound is 33:67 or more, and preferably 35:65 to 75:25.

In addition, even when the composition was in the appropriate range of the mass ratio described above, if a silyl compound in which two trialkoxysilyl groups were bonded to an alkane, such as bis(triethoxysilyl) ethane (BTEE), was not added as a silane compound having no epoxy group, even though the scratch resistance was good, the evaluation of the bending resistance and the surface hardness was very low.

### Production Examples 11 to 21

From the viewpoint of whether or not customer requirements are satisfied, bending characteristics, interlayer adhesion, and the like of a stacked hard coat film in which an antireflection layer and an antifouling layer are formed on a hard coat film are evaluated.

### [Composition for Forming Hard Coat and Hard Coat Film]

### <Preparation of Composition for Forming Hard Coat>

In the same manner as in Production Example 1, by using 8-glycidoxyoctyltrimethoxysilane (GOTMS) as the long-chain organosilicon compound and 3-glycidoxypropyltrimethoxysilane (GPTMS) as the short-chain organosilicon compound, compositions for forming a hard coat 11 to 21 having different mass ratios of the long-chain organosilicon compound to the short-chain organosilicon compound were prepared. The solid content composition of the composition for forming a hard coat is shown in Tables 2 and 3.

### <Preparation of Hard Coat Film>

Hard coat films 11 to 21 having a hard coat layer on a surface thereof were obtained in the same manner as in Production Example 1.

### [Evaluation of Characteristics of Hard Coat Layer]

The composition for forming a hard coat was applied onto a plastic film substrate with a Meyer bar, preliminarily dried at 80° C. for 1 minute, and then thermally cured at 130° C. for 2 minutes to obtain hard coat films 11 to 21 having a hard coat layer on the surface. The characteristics of these hard coat films 11 to 21 were measured in the same manner as in Production Example 1, and the results are shown in Table 2. Measurement conditions of the characteristics will be described later.

TABLE 2

| Hard coat film | | 11 | 12 | 13 | 14 | 15 | 16 | 17 | 18 | 19 | 20 | 21 |
|---|---|---|---|---|---|---|---|---|---|---|---|---|
| Compound | GOTMS | 100 | 75 | 57 | 50 | 42 | 40 | 35 | 33 | 20 | 14 | 0 |
| containing | GPTMS | 0 | 25 | 43 | 50 | 58 | 60 | 65 | 67 | 80 | 86 | 100 |
| epoxy group | | | | | | | | | | | | |
| Mass ratio*¹ | | | | | | | | | | | | |
| Compound | BTEE | 31 | 31 | 30 | 31 | 30 | 32 | 32 | 31 | 30 | 22 | 30 |
| containing no | | | | | | | | | | | | |
| epoxy group | | | | | | | | | | | | |
| Mass ratio*² | | | | | | | | | | | | |
| Mandrel test | Number of passes | 20 | 40 | 30 | 30 | 40 | 40 | 40 | 15 | 5 | 30 | 10 |
| R = 1 mm | (10,000 times) | | | | | | | | | | | |
| (outward | Number of fails | 25 | 45 | 35 | 35 | 45 | 45 | 45 | 20 | 10 | 35 | 15 |
| bending) | (10,000 times) | | | | | | | | | | | |

| | | | | | | | | | | | |
|---|---|---|---|---|---|---|---|---|---|---|---|
| Pencil hardness | 2H | 4H | 4H | 4H | 4H | 4H | 4H | 4H | 4H | 3H | 4H |
| Scratch resistance | B | A | A | A | A | A | A | A | A | A | A |

^{*1}Mass ratio of solid content of GOTMS:GPTMS
^{*2}Mass ratio of solid content of BTEE when (GOTMS + GPTMS) is set as 100

### <Evaluation Results>

In order to reproduce the evaluation results for Production Example 1 to 9 and to obtain a composition for forming a hard coat having both high bending resistance and high surface hardness, it has been reconfirmed that the appropriate mass ratio of the long-chain organosilicon compound to the short-chain organosilicon compound is 33:67 or more, and preferably 35:65 to 75:25.

### <Formation of Antireflection Layer>

In a 2 L beaker, 73.2 g (7.32 parts by mass) of hollow colloidal silica sol (product name: THRULYA 4110, available from JGC Catalysts and Chemicals Ltd., solid content concentration: 20%), 200 g (20 parts by mass) of isopropyl alcohol (IPA), and 20 g (2 parts by mass) of 0.02 N hydrochloric acid were mixed under stirring, and the mixture was stirred at room temperature. A mixture of 10.6 g (1.06 parts by mass) of 3-glycidoxypropyltrimethoxysilane (GPTMS) and 19.9 g (1.99 parts by mass) of methyltriethoxysilane (MTES) was added dropwise thereto at room temperature over 1 hour. Thereafter, the solution temperature was raised to 50° C., and the mixture was stirred at that temperature for 2 hours. After cooling, 2.4 g (0.24 parts by mass) of aluminum trisacetylacetonate and 673.9 g (67.39 parts by mass) of IPA were further added to prepare 1 kg (100 parts by mass) of a composition for forming an antireflection film. The refractive index after formation of the coating film was 1.35.

The composition for forming a hard coat was coated on a plastic film substrate with a Meyer bar, and preliminarily dried at 80° C. for 1 minute to form a semi-cured hard coat layer on a substrate.

The composition for forming an antireflection film was applied onto the semi-cured hard coat layer of the hard coat films 11 to 21 with a Meyer bar, and pre-dried at 80° C. for 1 minute to form a semi-cured antireflection layer on the hard coat layer.

### <Formation of Antifouling Layer>

A fluorine chain-containing trialkoxysilane-based antifouling coating agent was applied onto the semi-cured antireflection layer of the hard coat films 11 to 21 with a Meyer bar, and pre-dried at 80° C. for 1 minute to form a semi-cured antifouling layer on the hard coat layer.

### <Formation of Stacked Structure of Three Layers>

In a state where three layers of a semi-cured hard coat layer, an antireflection layer, and an antifouling layer were formed, the hard coat film was thermally cured at 130° C. for 2 minutes to obtain hard coat films 11 to 21 having a three-layer structure including a hard coat layer, an antireflection layer, and an antifouling layer on the surface.

### [Evaluation of Characteristics of Hard Coat Layer]

The characteristics of the hard coat films 11 to 21 obtained in the above Production Examples 11 to 21 were measured, and the results are shown in Table 3. Measurement conditions of the characteristics will be described later.

TABLE 3

| Hard coat film | | 11 | 12 | 13 | 14 | 15 | 16 | 17 | 18 | 19 | 20 | 21 |
|---|---|---|---|---|---|---|---|---|---|---|---|---|
| Compound | GOTMS | 100 | 75 | 57 | 50 | 42 | 40 | 35 | 33 | 20 | 14 | 0 |
| containing | GPTMS | 0 | 25 | 43 | 50 | 58 | 60 | 65 | 67 | 80 | 86 | 100 |
| epoxy group | | | | | | | | | | | | |
| Mass ratio*¹ | | | | | | | | | | | | |
| Compound | BTEE | 31 | 31 | 30 | 31 | 30 | 32 | 32 | 31 | 30 | 22 | 30 |
| containing no | | | | | | | | | | | | |
| epoxy group | | | | | | | | | | | | |
| Mass ratio*² | | | | | | | | | | | | |
| Mandrel test | Number of passes | 40 | 40 | 40 | 40 | 40 | 40 | 40 | 40 | 40 | 40 | 40 |
| R = 3 mm | (10,000 times) | | | | | | | | | | | |
| (inward | | | | | | | | | | | | |
| bending) | | | | | | | | | | | | |
| Mandrel test | Number of passes | 40 | 40 | 40 | 40 | 40 | 40 | 40 | 40 | 40 | 40 | 40 |
| R = 5 mm | (10,000 times) | | | | | | | | | | | |
| (outward | | | | | | | | | | | | |
| bending) | | | | | | | | | | | | |

| | | | | | | | | | | | |
|---|---|---|---|---|---|---|---|---|---|---|---|
| Cross-hatch test | B | B | B | A | A | A | A | A | A | A | A |
| (Antireflection layer) | | | | | | | | | | | |
| Cross-hatch test | A | A | A | A | A | A | A | A | A | A | A |
| (Antifouling layer) | | | | | | | | | | | |

^{*1}Mass ratio of solid content of GOTMS:GPTMS
^{*2}Mass ratio of solid content of BTEE when (GOTMS + GPTMS) is set as 100

### <Evaluation Results>

From the viewpoint of whether or not customer requirements for a hard coat film on which a stacked structure of a hard coat layer, an antireflection layer, and an antifouling layer is formed are satisfied, in order to obtain a composition for forming a hard coat having both high bending resistance and high surface hardness, the appropriate mass ratio of the long-chain organosilicon compound to the short-chain organosilicon compound was 100:0 to 0:100. However, when the stacked structure was subjected to a cross-hatch test, delamination was not observed when the content of the short-chain organosilicon compound was 50% or more; whereas, when the content was less than 50%, the delamination was observed between the antireflection layer and the hard coat layer. That is, with respect to the adhesion of the formed layer, the appropriate mass ratio of the long-chain organosilicon compound to the short-chain organosilicon compound was 50:50 to 0:100. Therefore, it was found that the appropriate mass ratio of the long-chain organosilicon compound to the short-chain organosilicon compound that comprehensively satisfies the customer requirements is 50:50 to 0:100. Here, the “customer requirements” means that a crack does not occur even after 200,000 repetitions in both the bending test (inward bending test) in which the bending diameter is set to a radius of 3 mm and the hard coat coating surface is set to the inner side and the bending test (outward bending test) in which the bending diameter is set to a radius of 5 mm and the hard coat coating surface is set to the outer side.

In addition, in a test that requires stricter requirements than customer requirements for the hard coat film in which only the hard coat layer is formed, that is, a test that requires that the bending diameter is set to a radius of 1 mm and that cracks do not occur even if the bending test (outward bending test) is repeated 150,000 times and the hard coat coating surface is set to the outer side, the appropriate mass ratio of the long-chain organosilicon compound to the short-chain organosilicon compound was 33:67 or more, and preferably 35:65 to 75:25.

When considering, in addition to the customer requirements, the above strict requirements, the appropriate mass ratio of long-chain organosilicon compound to the short chain organosilicon compound is 33:67 to 50:50.

### [Method for Evaluating Characteristics of Hard Coat Layer]

### <Mandrel Bending Test>

In order to evaluate the bending resistance, a bending resistance test was performed using a planar body unloaded U-shaped stretching tester DLDMLH-FS available from YUASA SYSTEM Co., Ltd.

Specifically, the bending test was repeated 50,000 times at 60 reciprocations/min with the bending diameter set to the radius R mm, and then the presence or absence of crack generation was evaluated. If no crack is generated, it is determined as acceptable. The presence or absence of the occurrence of the crack is evaluated every time the bending is repeated 50,000 times, and the evaluation is performed in the same manner until the crack occurs and the film fails.

The customer requirements are that a crack does not occur even after 200,000 repetitions in the bending test (inward bending test) in which the bending diameter is set to a radius of 3 mm and the hard coat coating surface is set to the inner side and a crack does not occur even after 200,000 repetitions in the bending test (outward bending test) in which the bending diameter is set to a radius of 5 mm and the hard coat coating surface is set to the outer side.

Furthermore, in the present invention, as a stricter requirements than customer requirements, the bending test (outward bending test) in which the bending diameter is set to a radius of 1 mm and the hard coat coating surface is set to the outer side was performed.

### <Pencil Hardness of Coating Film>

In order to evaluate the hardness of the coating film, a pencil hardness test was performed in accordance with JIS standard (JIS K 5600-5-4).

Specifically, a load of 750 g is applied to the pencil, and the surface is scratched with cores of different pencil concentrations, and the pencil hardness is defined as the hardest pencil concentration at which no scratch occurs. The pencil density is 6B, 5B, 4B, 3B, 2B, B, HB, F, H, 2H, 3H, 4H, 5H, and 6H from the soft side to the hard side.

### <Scratch Resistance Test of Coating Film (Steel Wool Scratch Test)>

In order to evaluate the scratch resistance of the coating film, a steel wool scratch test was performed under the following conditions.

#0000 steel wool was fixed to a steel wool holder of a surface property measuring machine (Model number: TYPE14DR, available from Shinto Scientific Co., Ltd.), and a load of 2 kg was applied to the steel wool holder to reciprocate and rub the surface 10 times. The evaluation criteria are as follows.

A . . . Scratches are not observed.

B . . . Slight scratches are observed.

C . . . Deep scratches are observed.

### <Adhesion of Coating Film>

In order to evaluate the adhesion, a crosshatch test at 100 squares was performed in accordance with the checkerboard testing method of JIS standard (JIS K 5600 Testing methods for paints).

Specifically, 11 cuts reaching the substrate are made in the coating film formed on the substrate at intervals of 1 mm using a single-blade cutting tool (cutter knife), 11 cuts are made in the same manner while the direction is changed by 90°, and the cuts are made in a checkerboard pattern. An adhesive tape is attached on the cuts in the checkerboard pattern. This tape is kept at a right angle to the coating film surface and peeled off at once.

This was repeated 10 times, and the state of the coating film was visually observed. Evaluation criteria are shown below.

A . . . The number of squares on which peeling was not observed was 95 or more out of 100 squares.

B . . . The number of squares on which peeling was not observed was less than 95 out of 100 squares.

### INDUSTRIAL APPLICABILITY

When the composition for forming a hard coat of the present invention is used, a coating film can be formed on the surface of a useful resin film substrate with good adhesion, and therefore, the composition has not only a hard coat for a plastic substrate made of polycarbonate, which is a known application, but also high bending resistance and surface hardness. Therefore, it is also very useful as a hard coat for a flexible resin film substrate such as polyimide that has attracted attention in recent years.

### REFERENCE SIGNS LIST

1 Resin substrate
2 Composition layer for forming hard coat
3 Cured layer (hard coat)
4 Primer

1. A composition for forming a hard coat, comprising at least:
a component A: metal oxide fine particles;
a component B: an organosilicon compound represented by a general formula (1)
[Chem. 1]
(R¹O)ₐSi(R²)₄₋ₐ (1)
(wherein a represents an integer of 1 to 3, one or more les represent the same or different hydrocarbon groups having 1 to 3 carbon atoms, respectively, and one or more les represent the same or different hydrocarbon groups substituted with a glycidoxy group, respectively), in which the hydrocarbon group substituted with the glycidoxy group represented by R² is a mixture of a hydrocarbon group having (6 to 18) carbon atoms and a hydrocarbon group having (1 to 5) carbon atoms, a hydrolysate thereof and a partially hydrolyzed oligomer, and a bistrialkoxysilyl compound represented by a general formula (2),
[Chem. 2]
(R³O)₃Si—(CH₂)_{b}—Si(OR⁴)₃ (2)
(wherein b represents an integer of 1 to 3, three les represent the same or different hydrocarbon groups having 1 to 3 carbon atoms, respectively, and three R⁴s represent the same or different hydrocarbon groups having 1 to 3 carbon atoms, respectively);
a component C: an adhesion promoting component having an alkoxysilyl group;
a component D: a curing catalyst; and
a component E: a solvent.

2. The composition for forming a hard coat according to claim 1, wherein in a mixture of the organosilicon compound having a hydrocarbon group having 6 to 18 carbon atoms substituted with a glycidoxy group and the organosilicon compound having a hydrocarbon group having 1 to 5 carbon atoms substituted with a glycidoxy group, a mass ratio between the organosilicon compound having a hydrocarbon group with 6 to 18 carbon atoms substituted having a glycidoxy group and the organosilicon compound having a hydrocarbon group having 1 to 5 carbon atoms substituted with a glycidoxy group is 50:50 to 0:100 as a solid composition.

3. The composition for forming a hard coat according to claim 1, wherein the adhesion promoting component having an alkoxysilyl group has an alkoxysilyl group as a reactive functional group bonded to both ends of a compound selected from the group consisting of polyurethane, polyester, polycarbonate, and polyester carbonate.

4. The composition for forming a hard coat according to claim 1, wherein
the adhesion promoting component having an alkoxysilyl group is a compound, having alkoxysilyl groups at both ends, represented by a general formula (3), 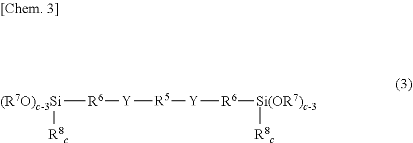
(wherein, c represents an integer from 0 to 2, R⁵ represents an adhesion promoting polymer main chain selected from the group consisting of polyurethane, polyester, polycarbonate, and polyester carbonate, two R⁶s represent the same or different alkylene groups having 1 to 20 carbon atoms, respectively, the alkylene group may have an unsaturated hydrocarbon group, an aromatic hydrocarbon group, an alicyclic hydrocarbon group or a heteroatom, one or more les and les represent the same or different alkyl groups having 1 to 4 carbon atoms, respectively, and two Ys are the same or different chemical bonds selected from the group consisting of an amide bond, an imide bond, an urethane bond, a urea bond, an ether bond, an ester bond, a carbonate bond, a sulfide bond, a thiourethane bond, a thiourea bond, a thioester bond, respectively).

5. A laminate comprising:
a resin substrate; and
a hard coat layer directly formed on the resin substrate,
wherein the hard coat layer is a cured product of the composition for forming a hard coat according to claim 1.

6. The laminate according to claim 5, wherein the resin substrate is a film of an optical resin selected from the group consisting of polycarbonate, polyimide, polyester, a cycloolefin polymer, polyaramid, and cellulose triacetate, or a blend resin thereof.

7. The laminate according to claim 5, wherein the resin substrate is a polyimide flexible film.
